(19) United States
(12) Patent Application Publication
(10) Pub. No.: US 2008/0136976 A1
(43) Pub. Date: Jun. 12, 2008

(54) Geometric Correction Method in Multi-Projection System

(75) Inventors: Takeyuki Ajito, Tokyo (JP); Kazuo Yamaguchi, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/661,616

(22) PCT Filed: Aug. 8, 2005
(86) PCT No.: PCT/JP05/14530

§ 371 Date: Feb. 27, 2007

(30) Foreign Application Priority Data
Sep. 1, 2004 (JP) 2004-254367

(51) Int. Cl. G06F 3/14

(52) U.S. Cl. 348/745; 348/E17.001

(57) ABSTRACT

A geometrical correcting method allowing geometrical correction to be performed simply, accurately and in short a time, even in a multi-projection system including a screen of complex shape and projectors complexly arranged, for significantly improving the maintenance efficiency. Test pattern images having feature points are projected by respective projectors, and captured and displayed on a monitor, approximate positions of the feature points are designated and input while referring to the displayed test pattern captured image, and the accurate positions of the feature points in the test pattern images are detected according to the approximate position information. An image correction data for aligning the images projected by the projectors is calculated from the detected positions based on the feature points, the coordinate information of the feature points in a predetermined test pattern image, and the coordinate position relationship between a separately predetermined contents image and the test pattern captured image.

### TECHNICAL FIELD

This invention relates to a multi-projection system projecting pictorial images in an overlapping relationship on a screen by using a plurality of projectors, and in particular to a geometric correction method for automatically correcting positional deviations between the respective projectors and distortions in the images by detecting such deviations and distortions by a camera.

### BACKGROUND ART

Multi-projection systems came to be widely used in recent years, for displaying combined images on a screen by a plurality of projectors in order to construct large-sized and high definition displays for showrooms in museums, exhibitions and the like, or for virtual reality (VR) systems and the like for use in simulation of theaters, automobiles, buildings, urban landscapes and the like.

In such multi-projection systems, it is important to adjust or correct positional deviations of images and color shifting for finely combining the images on a screen. A method for this purpose has been proposed, which is to calculate the projecting positions of the projectors and to calculate the image correction data for making one pictorial image on a screen, from a plurality of images projected from the respective projectors (refer, for example, to patent document 1: JP 09-326981 A).

With the prior art method for calculating the image correction data disclosed in the patent document 1 identified above, test pattern images from the projectors are displayed on the screen and the test pattern images on the screen are captured by a digital camera, so as to calculate the projecting positions of the projectors from the captured images. More precisely, a plurality of feature points in the test pattern captured images are detected by using such a technique as pattern matching or the like, and the parameters of the projecting positions are calculated based on the detected positions of the feature points so as to calculate the image correction data for correcting the projecting positions of the projectors.

With such a method for calculating the image correction data, however, when the shape of the screen is complicated or the arrangement of the projectors is complicated and the orientations of the projected images have been remarkably rotated, it may become difficult to find correspondences between the detected feature points in the captured images and the plurality of feature points in the original test pattern images.

In order to avoid such a problem, there has been proposed a method for displaying and capturing the feature points one by one, for accurately detecting the feature points individually. Another method has also been proposed, which is to previously set approximate detection areas for the respective feature points depending upon the arrangement of the projectors and camera and the shape of the screen, and to perform detection of the respective feature points with a successive correlation according to the respective detection areas (refer, for example, to patent document 2: JP 2003-219324A).

### DISCLOSURE OF THE INVENTION

### Problem to be Solved by the Invention

With the method disclosed in the patent document 2, however, when the shape of the screen is complicated and the number of the feature points is large, the feature points are projected and captured one by one, and the capturing of all the feature points thus takes significant time. Furthermore, when the detection areas are previously set, even a slight shifting of the camera from the previously set position requires the detection areas to be set again, resulting in significant time for resetting and low maintenance efficiency. These problems remain to be solved.

In view of these circumstances, therefore, it is an object of the present invention to provide a geometric correction method in a multi-projection system, which can simply and accurately perform the geometric correction in short a time, thereby significantly improving the maintenance efficiency even if the multi-projection system includes a screen having a complicated shape and projectors of complicated arrangement.

### Solution of the Problem

In order to achieve the above-mentioned object, a first aspect of the present invention resides in a geometric correction method in a multi-projection system for displaying a contents image on a screen by combining images projected from a plurality of projectors, including a geometric correction data calculating step for calculating geometric correction data for alignment of the images projected from said projectors, said geometric correction data calculating step comprising:

a projecting step of projecting a test pattern image composed of a plurality of feature points from each of said projectors onto said screen;

a capturing step of capturing the test pattern images projected onto said screen in said projecting step as test pattern captured images obtained by means of capturing means;

a displaying step of displaying on a monitor the test pattern captured images incorporated in said capturing step;

an inputting step of designating and inputting approximate positions of the feature points in said test pattern captured images, while referring to the test pattern captured images displayed in said displaying step;

a detecting step of detecting accurate positions of the respective feature points in said test pattern images based on the approximate position information input in said inputting step; and

a calculating step of calculating image correction data for the alignment of the images projected by said respective projectors based on the positions of the feature points in said test pattern captured images detected in said detecting step, previously given coordinate information of the feature points in the test pattern images, and separately predetermined coordinate position relationship between the contents images and the test pattern captured images.

A second aspect of the present invention resides in the geometric correction method in a multi-projection system according to the first aspect, wherein:

said inputting step is carried out by designating, as said approximate positions of the feature points in said test pattern captured images, positions of a smaller number of the feature points than the number of the feature points in said test pattern captured images, and inputting the designated positions in a predetermined order previously set; and

said detecting step is carried out by predicting approximate positions of all the feature points in the test pattern images by interpolating operation based on said approximate positions input in said inputting step, and detecting accurate positions of the respective feature points in the test pattern images from the predicted approximate positions of the feature points.

A third aspect of the present invention resides in the geometric correction method in a multi-projection system according to the second aspect, wherein said approximate positions of the feature points in said test pattern captured images in said inputting step are positions of a plurality of the feature points positioned in the outermost portions of the test pattern captured images.

A fourth aspect of the present invention resides in the geometric correction method in a multi-projection system according to the second aspect, wherein said approximate positions of the feature points in said test pattern captured images in said inputting step are positions of four feature points positioned at four outermost corners in the test pattern captured images.

A fifth aspect of the present invention resides in the geometric correction method in a multi-projection system according to any one of the first to fourth aspects, wherein said test pattern images have marks added for identifying the feature points to be designated in said inputting step, beside a plurality of feature points.

A sixth aspect of the present invention resides in the geometric correction method in a multi-projection system according to any one of the first to fourth aspects, wherein said test pattern images have marks added for identifying the order of feature points to be designated in said inputting step, beside a plurality of feature points.

A seventh aspect of the present invention resides in the geometric correction method in a multi-projection system recited in any one of the first to sixth aspects, wherein, after said capturing step, said geometric correction data calculating step further comprises a light shielding step for reducing projection luminance at boundary portions of the images projected by said respective projectors.

An eighth aspect of the present invention resides in a geometric correction method in a multi-projection system for displaying one contents image on a screen by combining images projected from a plurality of projectors, wherein the method includes a geometric correction data calculating step for calculating geometric correction data for alignment of the images projected from said projectors, said geometric correction data calculating step comprising:

a projecting step of projecting a test pattern image composed of a plurality of feature points from each of said projectors onto said screen;

a capturing step of capturing the test pattern images projected onto said screen in said projecting step as test pattern captured images obtained by capturing the test pattern images by means of capturing means;

a multiple projecting step of sequentially projecting onto said screen a plurality of single feature point images each composed of a different feature point among typical feature points whose number is less than that of the feature points in the test pattern images;

a multiple capturing step of capturing the plurality of single feature point images sequentially projected onto said screen in said multiple projecting step to incorporate as single feature point captured images;

a preliminary detecting step of detecting accurate positions of the respective feature points from the plurality of single feature point captured images obtained in said multiple capturing step;

a detecting step of detecting accurate positions of the respective feature points in said test pattern captured images based on the positions of the respective feature points in the plurality of single feature point captured images detected in said preliminary detecting step; and

a calculating step of calculating image correction data for alignment of the images projected by said respective projectors based on the positions of the feature points in said test pattern captured images detected in said detecting step, previously given coordinate information of the feature points in the test pattern images, and separately determined coordinate position relationship between contents images and the test pattern captured images.

A ninth aspect of the present invention resides in the geometric correction method in a multi-projection system according to the eighth aspect, wherein, in said detecting step, approximate positions of the feature points in said test pattern captured images are predicted by polynomial approximation operation based on the positions of the respective feature points in the plurality of the single feature point captured images detected in said preliminary detecting step to detect accurate positions of the feature points in the test pattern captured images based on the predicted approximate positions.

A tenth aspect of the present invention resides in the geometric correction method in a multi-projection system according to the eighth or ninth aspect, wherein, after said multiple capturing step and said capturing step, said geometric correction data calculating step further comprises a light shielding step for reducing projection luminance at boundary portions of the images projected by said respective projections.

An eleventh aspect of the present invention resides in the geometric correction method in a multi-projection system recited in any one of the first to tenth aspects, said method further comprising:

a screen image capturing step of capturing the entire images on said screen as screen captured images by capturing the entire images on said screen by said capturing means;

a screen image displaying step of displaying the screen captured images obtained in said screen image capturing step on a monitor;

a contents coordinate inputting step of designating and inputting display area positions of contents images while referring to the screen captured images displayed in said screen image displaying step; and

a calculating step of calculating coordinate position relationship between the contents images and the screen captured images based on the contents display area positions in the screen captured images input in said contents coordinate inputting step,

wherein, in said calculating step, image correction data for the alignment of the images projected by said respective projectors are calculated based on the positions of the feature points in said test pattern captured images detected in said detecting step, previously given coordinate information of the feature points in the test pattern images, separately determined coordinate position relationship between the contents images and the test pattern captured images, and coordinate position relationship between the contents images and the screen captured images calculated in said calculating step.

A twelfth aspect of the present invention resides in the geometric correction method in a multi-projection system according to the eleventh aspect, wherein, in said screen image displaying step, said screen captured images obtained in said screen image capturing step are corrected for distortion depending on lens characteristics of said capturing means to display the corrected images onto said monitor.

### Effects of the Invention

According to the invention, it is possible to effect setting of detection areas of feature points as an initial setting for positioning in a multi-projection system by simplified and convenient manual operations by a user so that the geometric correction can be simply and accurately carried out in short a time without choosing wrong order of the feature points even if a screen having a complicated shape is used or projected images by projectors or captured images by capturing means have been remarkably tilted or rotated, thereby enabling the maintenance efficiency to be significantly improved.

### BRIEF DESCRIPTION OF THE DRAWINGS

FIG. 1 is a view illustrating the whole constitution of a multi-projection system for carrying out the geometric correction method according to the first embodiment of the invention;

FIGS. 2(a) and 2(b) are explanatory views illustrating examples of the test pattern images to be input into the projectors and the test pattern captured images captured by a digital camera in the first embodiment;

FIG. 3 is a block diagram illustrating the constitution of the geometric correction means in the first embodiment;

FIG. 4 is a block diagram illustrating the constitution of the geometric correction data calculating means shown in FIG. 3;

FIG. 5 is a flow chart illustrating the processing procedure according to the geometric correction method of the first embodiment;

FIGS. 6(a) and 6(b) are a flowchart and an explanatory view, respectively, illustrating the detail of the detection area setting process in step S2 in FIG. 5;

FIGS. 7(a) and 7(b) are a flowchart and an explanatory view, respectively, illustrating the detail of the contents display area setting process in step S7 in FIG. 5;

FIG. 8 is an explanatory view illustrating a modification of the first embodiment, in which a cylindrical screen is used and the captured images of the cylindrical screen are transformed into, and displayed as rectangular images for setting the contents display regions;

FIG. 9 is an explanatory view illustrating a further modification of the first embodiment, in which a dome-shaped screen is used and the captured images of the dome-shaped screen are transformed into, and displayed as rectangular images for setting the contents display regions;

FIG. 10 is an explanatory view illustrating a still further modification of the first embodiment, for explaining another example of the setting of the contents display areas;

FIGS. 11(a) to 11(d) are explanatory views illustrating examples of the test pattern images input into the projectors and the test pattern captured images captured by the digital camera according to the second embodiment of the invention;

FIG. 12 is a block diagram illustrating the constitution of the geometric correction means according to the third embodiment of the invention;

FIG. 13 is an explanatory view illustrating the fourth embodiment of the invention;

FIG. 14 is a block diagram illustrating the constitution of the geometric correction means in the fourth embodiment;

FIG. 15 is an explanatory view illustrating one example of the dialogue box to be used in inputting in the test pattern image information inputting section shown in FIG. 14;

FIG. 16 is an explanatory view similar to FIG. 15, but illustrating another example;

FIG. 17 is a flow chart illustrating the processing procedure according to the geometric correction method of the fourth embodiment;

FIG. 18 is an explanatory view illustrating a modification of the fourth embodiment;

FIGS. 19(a) to 19(d) are explanatory views illustrating the fifth embodiment of the invention;

FIG. 20 is a block diagram illustrating the constitution of the geometric correction means in the fifth embodiment;

FIG. 21 is a flow chart illustrating the processing procedure according to the geometric correction method of the fifth embodiment;

FIGS. 22(a) and 22(b) are explanatory views illustrating examples of test pattern images and single feature point images input into the projectors in the sixth embodiment of the invention;

FIG. 23 is a block diagram illustrating the constitution of the geometric correction means in the sixth embodiment;

FIG. 24 is a block diagram illustrating the constitution of the detection area setting means shown in FIG. 23;

FIG. 25 is a flowchart illustrating the procedure of all the processes for the geometric correction method in the sixth embodiment of the invention;

FIG. 26 is an explanatory view for explaining the seventh embodiment of the invention;

FIG. 27 is an explanatory view illustrating another modification of the invention; and

FIG. 28 is an explanatory view illustrating still another modification of the invention.

### BEST MODE FOR CARRYING OUT THE INVENTION

The configuration of preferred embodiments of the invention will be explained below with reference to the accompanying drawings.

### First Embodiment

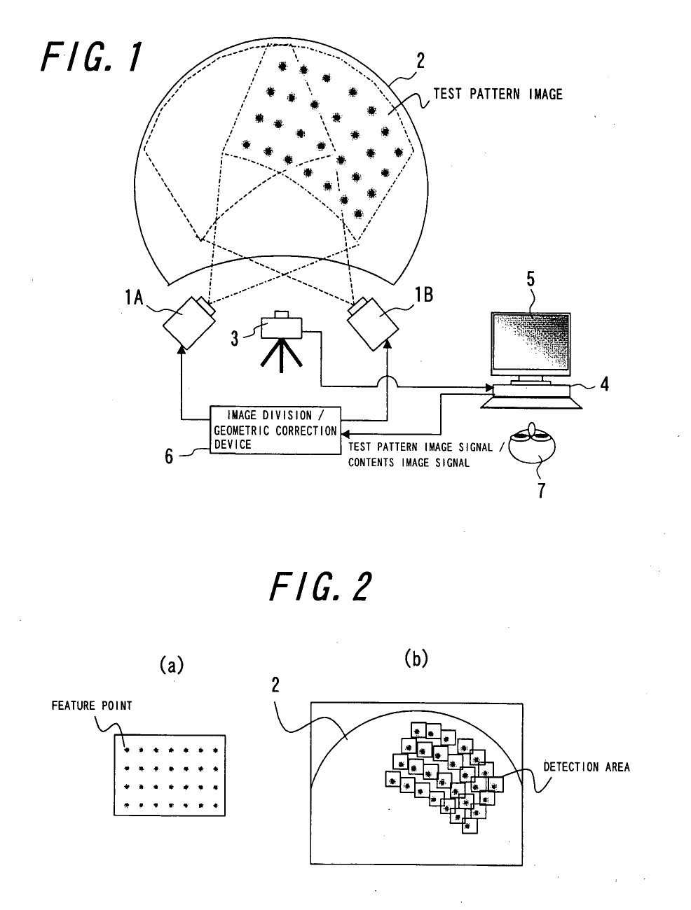

FIGS. 1 to 7 illustrate the configuration of the first embodiment according to the invention.

A multi-projection system according to the present embodiment, the entirety of which is illustrated in FIG. 1, comprises a plurality of projectors (projectors 1A and 1B in this case), a dome-shaped screen 2, a digital camera 3, a personal computer (PC) 4, a monitor 5, and an image division/geometric correction device 6. Pictorial images are projected onto the screen 2 by means of the projectors 1A and 1B so that the projected images are combined with one another to display one large pictorial image on the screen 2.

In such a multi-projection system, if the pictorial images are simply projected from the projectors 1A and 1B, the respective projected images may not be snugly combined with one another due to color characteristics of the respective projectors, deviations in the projecting positions, and distortions in the images projected onto the screen 2.

In the present embodiment, therefore, test pattern image signals transmitted from the PC 4 are input into the projectors 1A and 1B (without image division and geometric correction) and the test pattern images projected onto the screen 2 are captured by the digital camera 3 to obtain test pattern captured images. In this case, the test pattern images to be projected onto the screen 2 consist of feature points (markers) regularly lined up on the picture plane, as shown in FIG. 2(a).

The test pattern captured images obtained by the digital camera 3 are transmitted to the PC 4 and used for calculating geometric correction data for the alignment or positioning of the respective projectors. On this occasion, the test pattern captured images are displayed by the monitor 5 associated with the PC 4 and displayed to an operator 7.

Subsequently, the operator 7 designates approximate positions of the feature points in the test pattern images by means of the PC 4, while referring to the displayed images. When the approximate positions of the feature points have been designated, the detection areas for the respective feature points as shown in FIG. 2(b) are set in the PC 4 based on the designated approximate positions, and then accurate positions of the feature points are detected based on the set detection areas. Thereafter, geometric correction data for the alignment or positioning of the respective projectors are calculated based on the detected positions of the feature points, and the calculated geometric correction data are then transmitted to the image division/geometric correction device 6.

In the image division/geometric correction device 6, moreover, division and geometric correction of contents images separately transmitted from the PC 4 are performed based on the geometric correction data described above, and the processed contents images are output to the projectors 1A and 1B. In this way, one neat contents image snugly combined with one another without junctures can be displayed on the screen 2 by a plurality of projectors (two projectors 1A and 1B in this case).

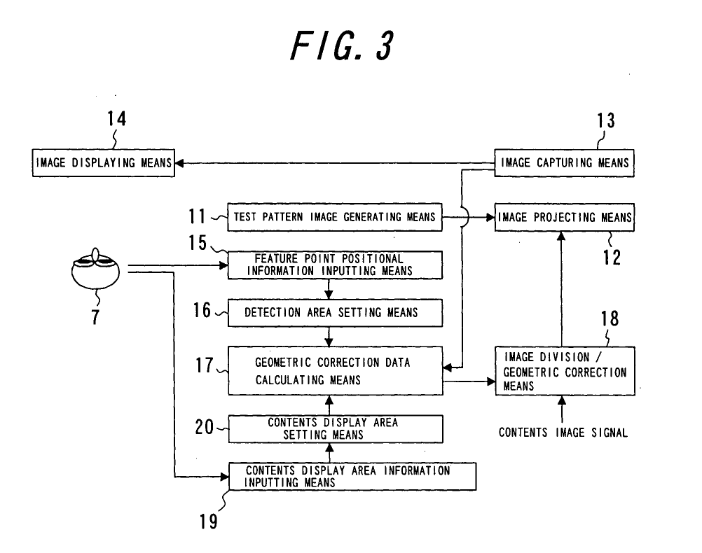

The constitution of geometric correction means according to the present embodiment will be explained below with reference to FIG. 3.

The geometric correction means in the present embodiment comprises test pattern image generating means 11, image projecting means 12, image capturing means 13, image display means 14, feature point position information inputting means 15, detection area setting means 16, geometric correction data calculating means 17, image division/geometric correction means 18, contents display area information inputting means 19, and contents display area setting means 20.

In this instance, the test pattern image generating means 11, feature point position information inputting means 15, detection area setting means 16, contents display area information inputting means 19, and contents display area setting means 20 are composed of the PC 4. The image projecting means 12 is composed of the projectors 1A and 1B. The image capturing means 13 is composed of the digital camera 3. The image display means 14 is composed of the monitor 5. The geometric correction data calculating means 17 and the image division/geometric correction means 18 are composed of the image division/geometric correction device 6.

The test pattern image generating means 11 produces test pattern images consisting of a plurality of feature points as shown in FIG. 2(a), and the image projecting means 12 inputs the test pattern images produced by the test pattern image generating means 11 to project them onto the screen 2. In addition, after a series of calculating operations for geometric correction to be described below, the image projecting means 12 inputs the contents images which have been divided and geometrically corrected by the image division/geometric correction device 6 and output therefrom, to project them onto the screen 2.

The image capturing means 13 captures the test pattern images projected onto the screen 2 by the image projecting means 12, and the image display means 14 displays the test pattern captured images captured by the image capturing means 13 to present the test pattern captured images to the operator 7.

The feature point position information inputting means 15 inputs approximate positions of the feature points in the designated test pattern captured images by the operation of the operator 7 with reference to the test pattern captured images displayed on the image display means 14. The detection area setting means 16 sets the detection areas of respective feature points in the test pattern captured images based on the approximate positions input from the feature point position information inputting means 15.

The contents display area information inputting means 19 inputs the information regarding the display area of contents to be designated by the operation of the operator 7 referring to the overall captured images on the screen 2 separately displayed on the image display means 14. The contents display area setting means 20 is input with the information regarding the display area of the contents from the contents display area information inputting means 19 to set the contents display area for the captured images, and outputs the set contents display area information to the geometric correction data calculating means 17.

The geometric correction data calculating means 17 detects accurate positions of the respective feature points in the test pattern captured images based on the test pattern captured images captured by the image capturing means 13 and the detection areas of the respective feature points in the test pattern captured images set by the detection area setting means 16. The geometric correction data calculating means 17 further calculates geometric correction data based on the detected accurate positions of the respective feature points and the contents display area information set by the contents display area setting means 20 to transmit the calculated geometric correction data to the image division/geometric correction means 18.

The image division/geometric correction means 18 performs division and geometric correction processes for the contents images input from the exterior based on the geometric correction data input by the geometric correction data calculating means 17, to output the processed results to the image projecting means 12.

In this way, accurate image division and geometric correction of the contents images input from the exterior can be performed in response to the display areas of the respective projectors, so that the contents images are displayed on the screen 2 as one snugly jointed image.

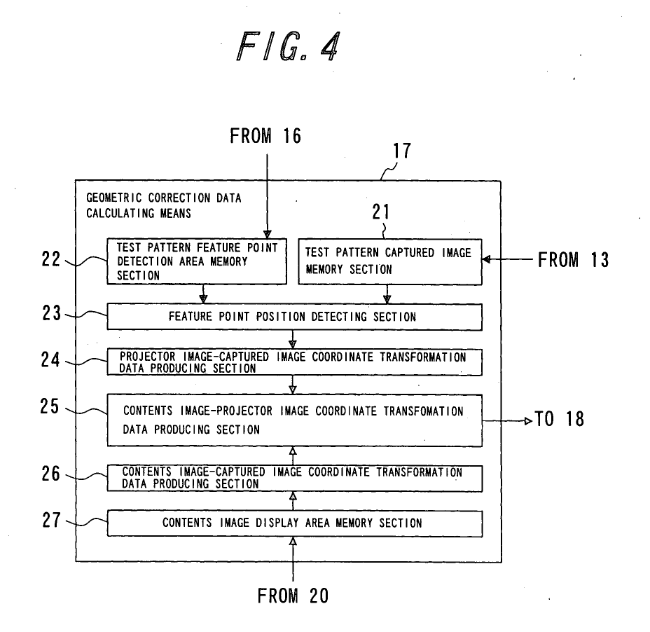

The construction of the geometric correction data calculating means 17 described above will be explained below in further detail, with reference to the block diagram of FIG. 4.

The geometric correction data calculating means 17 comprises a test pattern captured image memory section 21 inputting and storing test pattern captured images captured by the image capturing means 13, a test pattern feature point detection area memory section 22 inputting and storing the detection areas of the respective feature points of the test pattern captured images set by the detection area setting means 16, a feature point position detecting section 23, a projector image-captured image coordinate transformation data producing section 24, a contents image-projector image coordinate transformation data producing section 25, a contents image-captured image coordinate transformation data producing section 26, and a contents image display area memory section 27 inputting and storing the contents display area information set by the contents display area setting means 20.

The feature point position detecting section 23 detects accurate positions of the respective feature points in the test pattern captured images stored in the test pattern captured image memory section 21 based on the detection areas of the respective feature points stored in the test pattern feature point detection area memory section 22. As its concrete detecting method, applicable for this detecting process is the method for detecting accurate center positions (positions of the center of gravity) of the respective feature points as the maximum correlation values of the images within the corresponding detection areas as disclosed in the patent document 2 identified above.

The projector image-captured image coordinate transformation data producing section 24 produces the coordinate transformation data between the coordinates of the projector images and the coordinates of the test pattern captured images by the digital camera 3 based on the positions of the respective feature points in the test pattern captured images detected by the feature point position detecting section 23 and the previously given position information of the feature points of the original (i.e., prior to being input to the projectors) test pattern images. In this case, the coordinate transformation data may be stored as look-up tables (LUT) embedding the coordinates of the corresponding projector captured images per each of pixels of the projector images, or both coordinate transformation equations may be produced as a two-dimensional higher order polynomials. In the case of storing the data as look-up tables, moreover, the data concerning the coordinates other than the pixel positions assigned for the feature points may be preferably derived by using a linear interpolation, polynomial interpolation, spline interpolation or the like, based on the coordinate positional relationship between a plurality of respective adjacent feature points. In the case of storing the data as a two-dimensional higher order polynomial, furthermore, it may be preferable to perform the polynomial approximation by using the least square method, Newtonian method, maximum steep dropping method or the like, based on the coordinate relations in positions of the plurality of feature points.

The contents image-captured image coordinate transformation data producing section 26 produces the coordinate transformation data between the coordinates of the contents images and the coordinates of the captured images on the entire screen, based on the contents display area information stored in the contents image display area memory section 27. Now, for example, in the case of applying the rectangular coordinate information of the contents display area on the captured images to be described below, as the contents display area information, transformation tables or transformation formulas of the coordinates of the screen captured images for the coordinates of all the contents images are given in the contents image-captured image coordinate transformation data producing section 26 with the aid of the interpolation operation of the interior of rectangle or polynomial approximation based on the rectangular coordinate corresponding relationship.

Finally, the contents image-projector image coordinate transformation data producing section 25 produces the coordinate transformation tables or coordinate transformation formulas from the contents images to the projector images by using the projector image-captured image coordinate transformation data and contents image-captured image coordinate transformation data produced in the manner described above, so as to output them as the geometric correction data to the image division/geometric correction means 18.

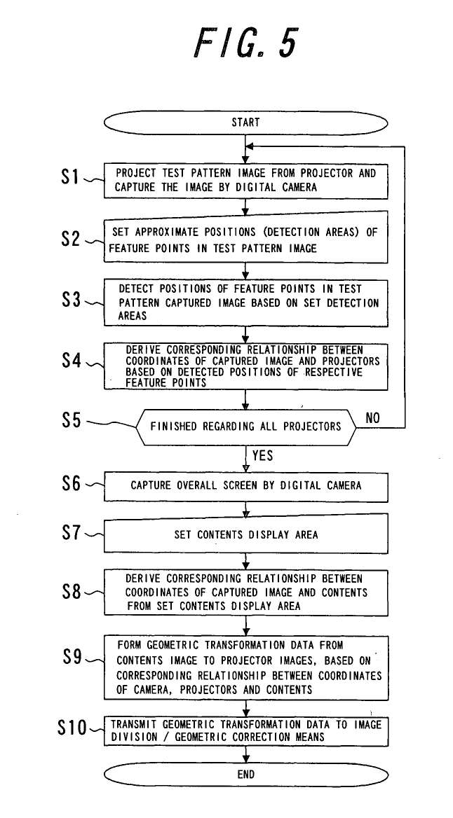

FIG. 5 is a flow chart illustrating the processing procedure for the geometric correction method according to the configuration of the embodiment of the invention described above. The flow chart includes steps S1 to steps S10 whose outline may overlap with the above description. Thus, the setting process for the detection areas in the step S2 and the setting process for the contents display areas in the step S7 will be explained in detail here, and the description of other processes is omitted.

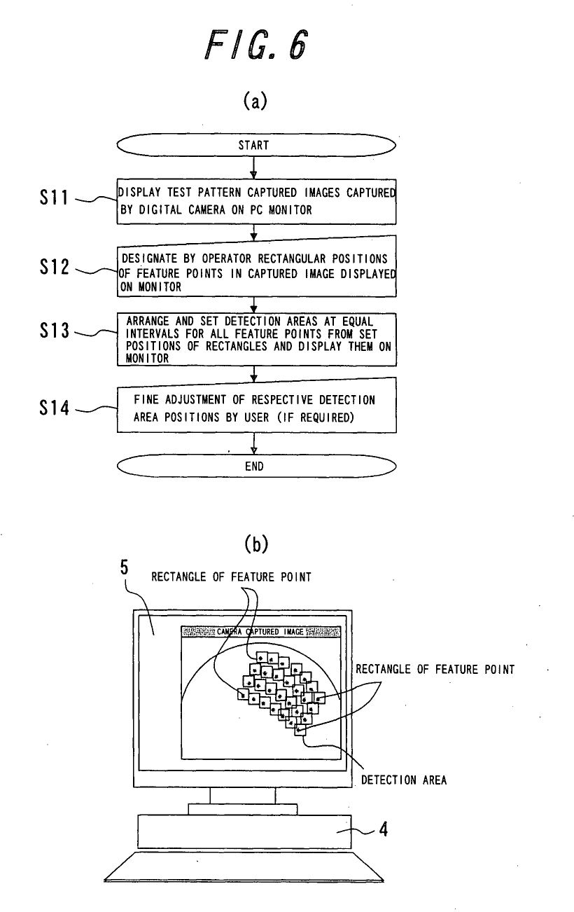

At the outset, the setting process of the detection areas in step S2 of FIG. 5 will be explained below with reference to FIG. 6(a) and (b).

In this instance, first of all, the test pattern captured images captured by the image capturing means 13 (digital camera 3) are displayed on the image display means 14 (i.e., the monitor 5 of the PC 4) (step S11). Then the operator 7 designates on the window of the PC 4, by means of a mouse or the like, the positions of the rectangles of the feature points as shown in FIG. 6(b) in the test pattern captured images displayed on the image display means 14 (step S12). On this occasion, the positions of the rectangles are designated in a previously determined order, for example, upper left, upper right, lower right, and lower left.

When all the rectangles have been designated, detection areas for all the feature points in the test pattern captured images are set based on the designated positions of the rectangles to display the set detection areas on the image display means 14 (the monitor 5) (step S13). In this instance, with respect to the feature points other than those at the four corners, they may be arranged and set by interpolation at equal intervals or by liner interpolation with projection transformation coefficient obtained from the positions of the four corners based on the designated positions of the rectangles and the numbers of the feature points in the X and Y directions.

Finally, if required, for example, when the detection areas deviate from the feature points, the operator 7 drags the displayed detection areas by means of a mouse or the like to finely adjust the positions (step S14), and after adjustment of all the detection areas, the operator 7 sets the positions of the detection areas to finish the process.

In the detection area setting process shown in FIG. 6(a), the feature points at the four corners are designated and the detection areas in their interiors are set at equal intervals, though it is apparent that the process is not limited to such a procedure. For example, in addition to the feature points at the four corners, more than four points on the outlines including intermediate points may be designated, or, in an extreme case, all the positions of the feature points (approximate positions) may be designated. The greater the number of designated points, the more difficult is the initial designating operation by the operator. In compensation for this, when the detection areas are set at equal intervals, the possibility of deviation from the feature points becomes lower so that there is a possibility that the fine adjustment may not be required. In the case of designation of more than four points, by calculating and setting the positions of the intermediate detection areas by means of the polynomial approximation or polynomial interpolation without using the setting at the equal intervals, there is a possibility that the detection areas can be set with high accuracy, even if the positions of the feature points captured are more or less distorted as in the case of a curved screen 2.

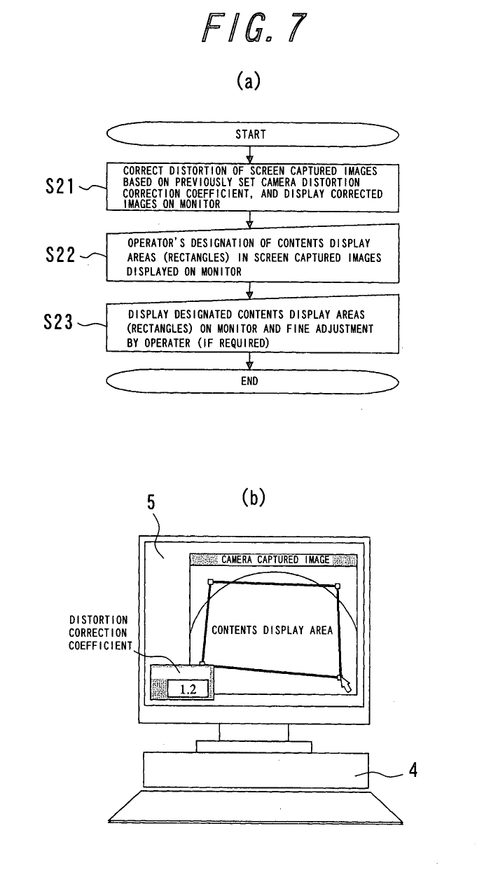

The process for setting the contents display areas in step S7 in FIG. 5 will be explained below in further detail with reference to FIG. 7(a) and (b).

In step S7, first of all, the images on the overall screen captured by the image capturing means 13 (the digital camera 3) are displayed on the image display means 14 (the monitor 5 of the PC 4). In this case, since the images captured by the image capturing means 13 (the digital camera 3) tend to cause image distortion due to camera lens, the images are displayed on the monitor 5 after the distortion of the captured images has been corrected by using a previously set lens distortion correction coefficient (step S21).

Then, the operator 7 designates by means of a mouse or the like a desired contents image display area as the four corner points of a rectangle in the screen captured images displayed on the monitor, whose distortions have been corrected as shown in FIG. 7(b) (step S22). Thereafter, the operator 7 performs fine adjustment of the four corner points of the rectangle by dragging operation with the mouse or the like as needed, while displaying the contents display areas in rectangular representation by the designated four corner points (step S23). After the fine adjustment has been completed, the coordinate positions of the rectangles in the captured images are set as the contents display area information, and the step routine is ended.

Incidentally, as the distortion correction coefficient used in the step S21, for example, there may be used a coefficient proportional to cube of the distance from the center of the image, or in order to improve their accuracy, a plurality of coefficients according to higher order polynomials. As shown in FIG. 7(b), furthermore, the operator 7 may perform the setting by repeatedly manually inputting distortion correction coefficients while watching screen captured images displayed on the monitor until the distortions of the images on the screen 2 are eliminated. Unless such distortion correction is accurately effected, the contents display areas are not displayed in the form of rectangles on the actual screen 2, even if the contents display areas are selected in the form of rectangles in the captured images. Therefore, it is desirable to effect the distortion correction as accurately as possible.

Moreover, using a cylindrical screen or dome screen, it is often desired to display images in such a manner that the images not only look rectangular when a viewer looks at the images from the position of the digital camera 3, but also look as if the rectangular images were arranged in proper combination at predetermined positions, for example, on the screen surface regardless of the position of the viewer (digital camera).

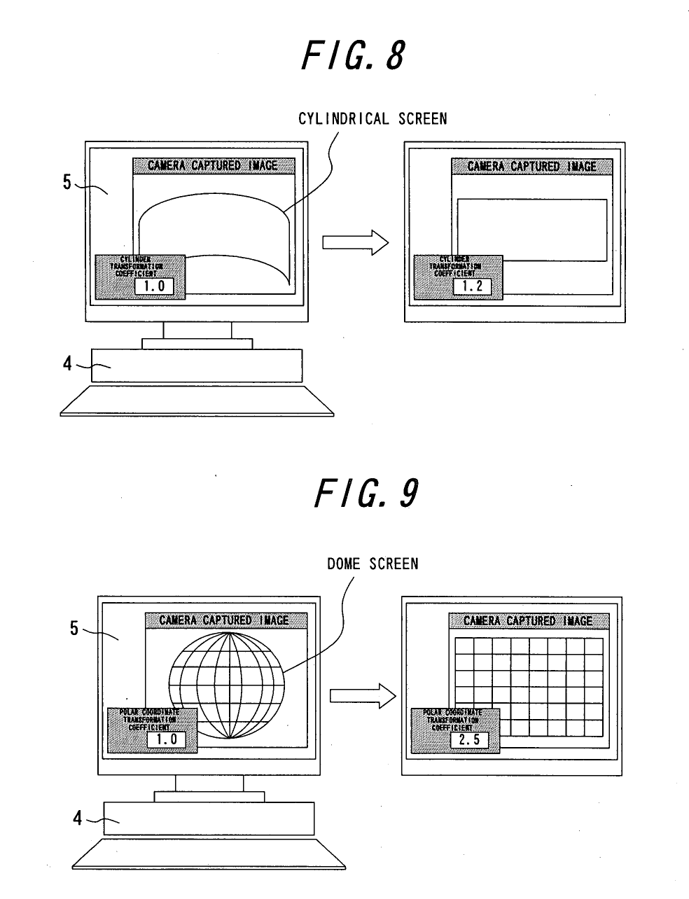

With the cylindrical screen in this case, for example, as shown in FIG. 8, a cylinder transformation process is applied to the captured images for transforming the distorted cylindrical screen in the captured images into a rectangular form, and thereafter the contents display region in the captured images processed by the cylinder transformation process is set to the rectangular form.

Moreover, the cylinder transformation process is also applied to the captured images of the feature points in the same manner as described above, and geometric correction data are obtained from the coordinate relationships between the projector images and the captured images and between the captured images and the contents images, thereby enabling the rectangular images to be actually displayed on the cylindrical screen.

On this occasion, if the coordinates of the original captured images are (x, y) and the coordinates of the captured images after the cylinder transformation are (u, v), the relationships therebetween (i.e., the relationships of the cylinder transformation) are represented as the following equation (1).

$$x = \frac{{K}_{x} sin ( u - {u}_{c} )}{cos ( u - {u}_{c} ) + a} + {x}_{c} \\ y = \frac{{K}_{y} ( v - {v}_{c} )}{cos ( u - {u}_{c} ) + a} + {y}_{c} \qquad ( 1 )$$

In the above equation, the symbols (x_{c}, y_{c}) and (u_{c}, v_{c}) are coordinates of the centers in the original captured images and captured images after the cylinder transformation, and the symbols Kₓ and K_{y} are parameters regarding angles of view of the captured images, while the symbol a is a cylinder transformation coefficient determined by the position of the camera and shape (radius) of the cylindrical screen.

The cylinder transformation coefficient a may be given as a predetermined value, if the arrangement of the camera and the shape of the cylindrical screen have been previously determined. However, for example, as shown in FIG. 8, by making it possible to arbitrarily set the coefficient a on the PC 4, a user can set the optimum parameter for the cylinder transformation coefficient by adjusting the screen to be displayed in the form of a rectangle while watching the captured images in live-display after the cylinder transformation, even if the exact arrangement of the camera and shape of the cylindrical screen are previously unknown. By this, it is possible to provide a multi-projection system with very high versatility. Of course, the parameters which can be set on the PC 4 by a user are not limited to the cylinder transformation coefficient a, and it may be possible to set the other parameters, for example, Kₓ and K_{y}.

In the case of using a dome screen, moreover, as shown in FIG. 9, it is possible to correct the screen surface distorted into a curved surface to a rectangular shape by a coordinate transformation for the captured images. In this case, a polar transformation process is applied to the captured images instead of the cylinder transformation, wherein the polar transformation can be indicated as the following equations (2).

$$x = \frac{{K}_{x} cos ( v - {v}_{c} ) sin ( u - {u}_{c} )}{cos ( v - {v}_{c} ) cos ( u - {u}_{c} ) + b} + {x}_{c} \\ y = \frac{{K}_{y} sin ( v - {v}_{c} )}{cos ( v - {v}_{c} ) cos ( u - {u}_{c} ) + b} + {y}_{c} \qquad ( 2 )$$

Here, the parameter b is a polar coordinate transformation coefficient determined depending upon the arrangement of the camera and shape (radius) of the dome screen. By making it possible to arbitrarily set the coefficient b on the PC 4 as shown in FIG. 9, the user can set the optimum parameter for the coefficient b by adjusting the screen to be displayed in the form of a rectangle while watching the captured images in live-display after the polar coordinate transformation, even if the exact arrangement of the camera and shape of the dome screen are previously unknown. Geometric correction data are obtained in this way so that the rectangular images can be actually displayed on the dome screen surface as if they were arranged in proper combination irrespective of the position of viewers.

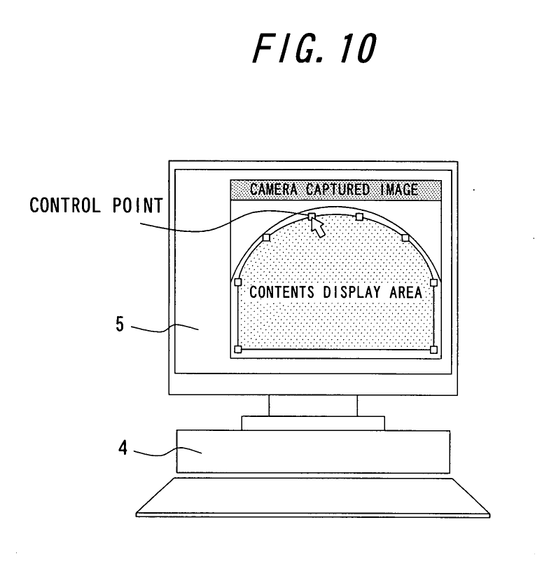

The contents display area may be set to be polygons or regions surrounded by curved lines, other than rectangles. In this case, the system is constructed to enable the apexes of the polygons or control points of the curved lines to be pointed and moved by a mouse, and corresponding thereto a user can arbitrarily set the contents areas while displaying the contents display areas in the polygons or curved lines as shown in FIG. 10. According to the contents areas surrounded by the polygons or curved lines set in this way, the coordinate transformation between the contents images and the captured images in the polygons or curved lines is effected by using interpolation formulas of polygons or curved lines, thereby making it possible to display the contents images conforming to the regions surrounded by the polygons or curved lines.

According to the embodiment described above, it is possible for the operator 7 to set the detection areas of the feature points for geometric correction in a simple manner, while watching the indication of the monitor 5 so that alignment or positioning of the displayed images by the projectors 1A and 1B can be effected exactly and reliably in a short period of time, even if the arrangements of the screen 2, projectors 1A and 1B and digital camera 3 of the multi-projection system are frequently changed. Moreover, the operator 7 can freely and simply set the areas in which the contents are to be displayed relative to the overall screen, while watching the monitor 5, thereby improving the maintenance efficiency of the multi-projection system.

### Second Embodiment

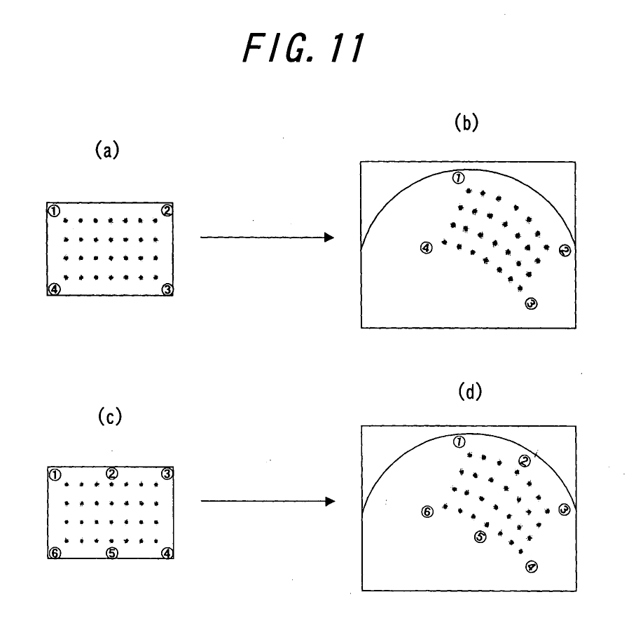

FIG. 11(a) to (d) illustrate the configuration of the second embodiment according to the invention.

In the second embodiment, the test pattern images produced in the test pattern image generating section are images having marks (numbers) added to the proximities of the feature points as shown in FIG. 11(a), instead of the test pattern images in the first embodiment as shown in FIG. 2(a). The other constructions and operations are similar to those in the first embodiment and hence, the explanation is omitted.

By using the images having marks (numbers) added to the proximities of the feature points as test pattern images in this manner, the displayed images can be selected in a corresponding order to enable the alignment or positioning without failures. This is because the points in the test pattern captured images to be designated have the numbers as markers as shown in FIG. 11(b), even if the individual projected images by the projectors are significantly rotated or reversed due to turnover of mirrors. When the operator 7 designates the approximate positions of the feature points with respect to not less than four points at the corners (for example, six points on the outline), by adding the numbers to the proximities of six points as shown in FIG. 11(c), the designation of the six points (particularly two intermediate points other than the four corner points) can be easily performed without failures. In addition to the numbers, the shapes of the feature points which are different from those of the other feature points may be indicated regarding said six points. Alternatively, the indication may be effected by changing the luminance or color of said six points.

According to the second embodiment described above, by adding marks such as numbers to the feature points in the test pattern images, errors in designation of the approximate positions of the feature points by the operator 7 can be reduced in the process for setting the detection areas of the feature points as shown in FIG. 6, so as to improve the maintenance efficiency.

### Third Embodiment

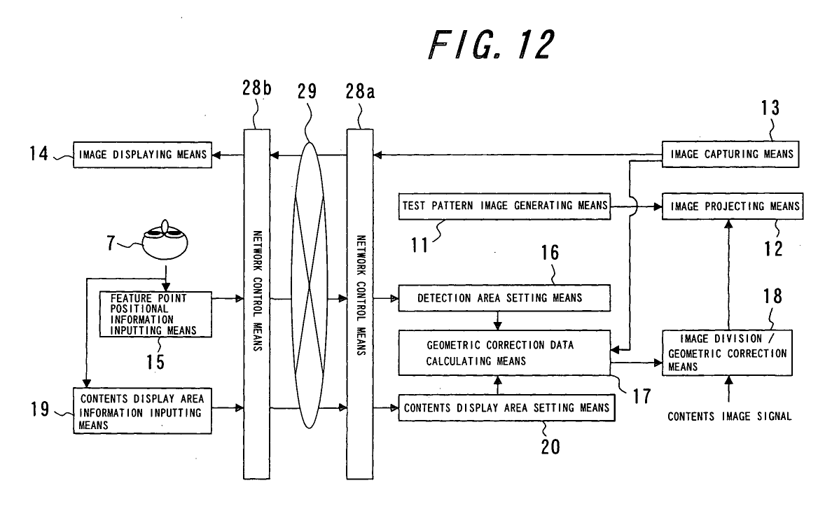

FIG. 12 is a block diagram illustrating the constitution of the geometric correction means according to the third embodiment of the invention.

In the present embodiment, network control means 28a and network control means 28b are provided in addition to the construction of the geometric correction means shown in the first embodiment (refer to FIG. 3). In more detail, the network control means 28a is connected through a network 29 to the network control means 28b positioned in a remote place, and transmits screen captured images and test pattern captured images captured by the image capturing means 13 to the network control means 28b through the network 29. The network control means 28a further receives approximate position information of the feature points and contents display area information transmitted through the network 29 from the network control means 28b, and outputs these information to the detection area setting means 16 and the contents display area setting means 20, respectively.

On the other hand, the network control means 28b receives the test pattern captured images and screen captured images transmitted through the network 29 by the network control means 28a, and outputs these received images to the image display means 14. The network control means 28b further transmits approximate position information of the feature points input in the feature point position information by an operator 7 and contents display area information input in the contents display area information inputting means 19 by the operator 7 to the network control means 28a through the network 29. In the present embodiment, moreover, a PC is provided in each of the remote place at the operator 7 and the place where the multi-projection system is located. The PC in the remote place constitutes the feature point position information inputting means 15 and contents display area information inputting means 19. On the other hand, the PC in the place of the system constitutes the test pattern image generating means 11, the detection area setting means 16 and the contents display area setting means 20.

According to the third embodiment constructed in this manner, the maintenance of the system can be carried out through the network 29, even if the operator 7 is in a remote place.

### Fourth Embodiment

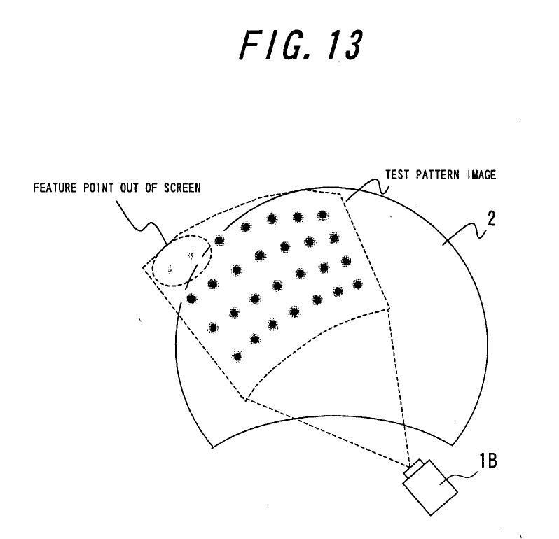

FIGS. 13 to 17 illustrate the configuration of the fourth embodiment according to the invention.

When part of images projected from the projector 1B extends beyond the screen 2 as shown in FIG. 13, the present embodiment makes it possible to adjust the display area of the feature points in test pattern images to some extent by an operator 7 in order to avoid a situation in which it is impossible to display part of the feature points due to “eclipse”, or “shading” caused by the screen 2 when projecting the test pattern images.

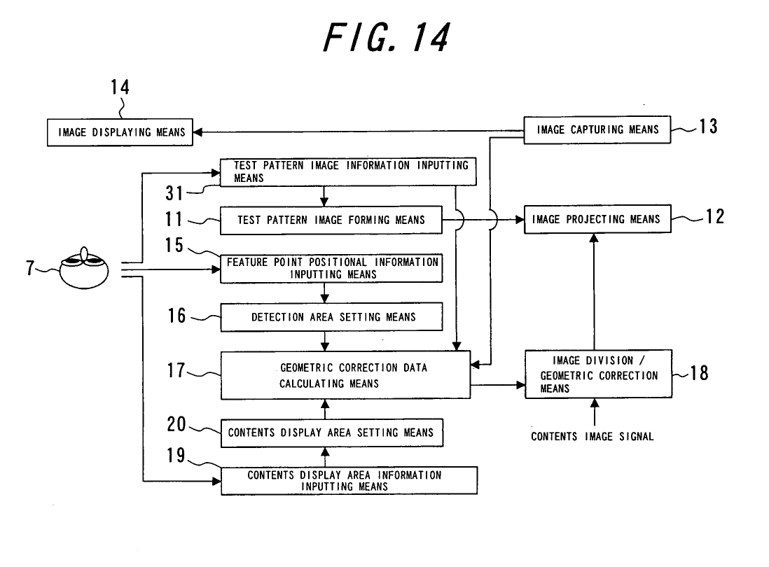

For this purpose, in the geometric correction means according to the present embodiment, as shown in FIG. 14 test pattern image information inputting means 31 is newly added to the construction of the geometric correction means of the first embodiment shown in FIG. 3. The test pattern image information inputting means 31 serves to set and input parameters of display areas and the like of the feature points by the operator 7, while referring to or watching the test pattern captured images prior to the adjustment displayed on the image display means 14 and further the test pattern image information inputting means 31 outputs these parameters to the test pattern image generating means 11 and the geometric correction data calculating means 17.

Moreover, the test pattern image generating means 11 produces test patterns based on parameters regarding test pattern images set by the test pattern image information inputting means 31 and outputs the test patterns to the image projecting means 12. Further, the geometric correction data calculating means 17 inputs information regarding the positions of the respective feature points which have been set among the parameters regarding the test pattern images set by the test pattern image information inputting means 31. The input information regarding the positions of the respective feature points will be used in deriving coordinate relationship between the projector images and the captured images.

The other components, that is, image projecting means 12, image capturing means 13, image display means 14, feature point position information inputting means 15, detection area setting means 16, image division/geometric correction means 18, contents display area information inputting means 19, and contents display area setting means 20 are substantially similar in function to those in the first embodiment.

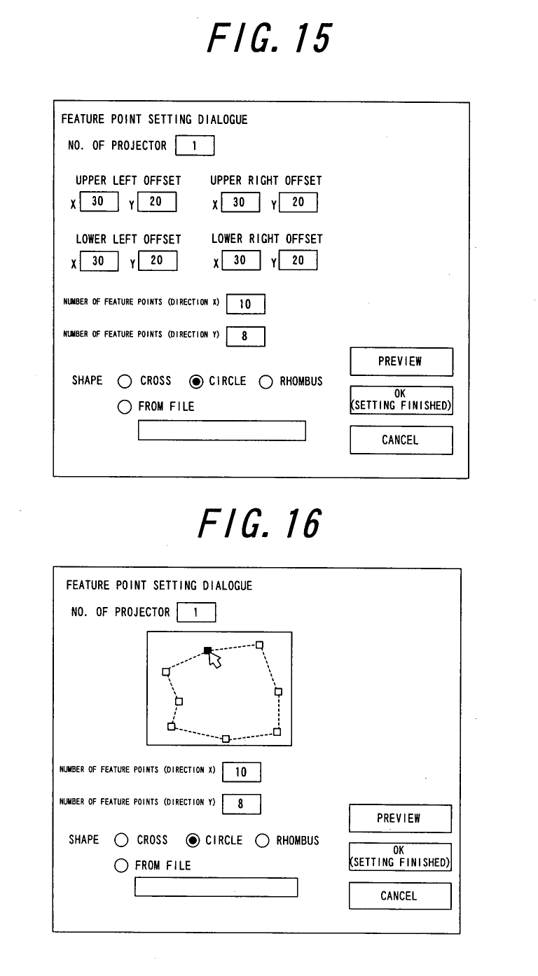

Here, the parameters regarding the test pattern images to be input in the test pattern image information inputting means 31 are set by the operator 7 who is watching the monitor 5 according to dialogues, for example, shown in FIGS. 15 and 16. More specifically, in the case of FIG. 15, first of all, the coordinate positions (pixels) of the respective feature points of the upper right end, upper left end, lower right end and lower left end as display areas of the feature points in the test pattern images are input with numerical values, and further the numbers of the feature points in the horizontal direction (direction X) and the vertical direction (direction Y) are input. Moreover, with respect to shapes of the feature points, some of shapes can be selected.

In the case of FIG. 16, on the other hand, the display areas of the feature points in test pattern images are adjusted by dragging the shapes of outer frames by means of a mouse without using coordinate values.

Based on the results of the setting in the manner described above, the test pattern images are formed in the test pattern image generating means 11 in the latter stage, and the test pattern images are projected by the image projecting means 12. The projected test pattern images are captured by the image capturing means 13, and the captured test pattern images are monitored or displayed on the image display means 14. Then, the displayed images are used to check if the feature points are eclipsed by the screen 2 and the like.

The operator 7 checks whether all the feature points are within the captured images in the way described above, and performs the resetting repeatedly until all the feature points are within the captured images. If all the feature points are within the images, the image projection and capturing are effected by using the test pattern images so that the detection areas are set and geometric correction data calculating process is carried out in the same manner as in the embodiment described above.

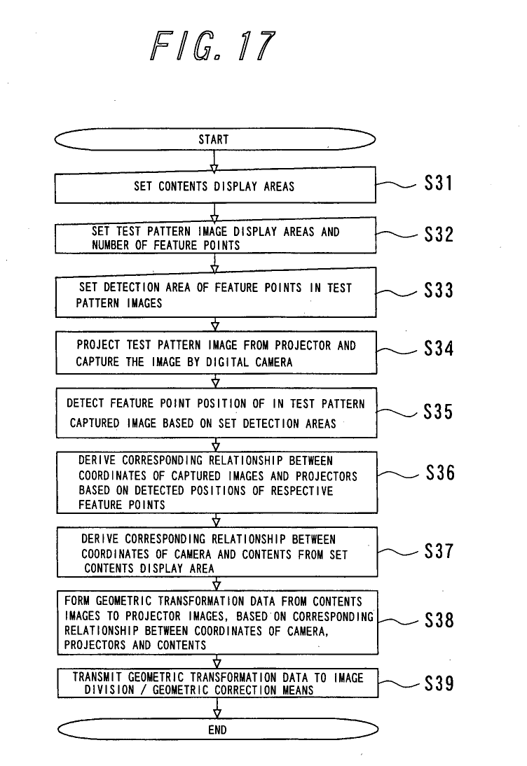

FIG. 17 is a flow chart illustrating the outline of the procedure for the geometric correction method according to the embodiment described above. The procedure is composed of steps S31 to S39 which substantially overlap with those described above and therefore will not be explained here.

According to the fourth embodiment described above, it is possible for the operator 7 to set the display areas of the feature points in the test pattern images while watching the monitor 5 to identifying the display areas of the feature points so that the alignment or positioning of the images displayed by the projectors 1A and 1B can be performed without causing errors even if part of images extends out of the screen 2.

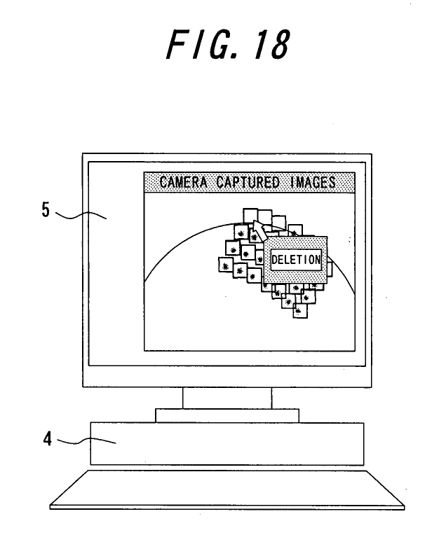

Although it is possible to set the test patterns so as not to extend out of the screen 2 according to the present embodiment, it is to be understood that if the test patterns extend out of the screen 2, a function may be provided for cutting off the detection areas corresponding to the feature points extending out of the screen, as shown in FIG. 18, for example. In this case, in the geometric operation to be executed later (more precisely, upon production of the coordinate transformation data between the captured images and the projector images), calculation or operation may be effected without using the information of the feature points corresponding to the deleted detection areas, but using the information of the feature points corresponding only to the remaining detection areas. In this way, the images can be combined on the screen surface without causing errors even if the test patterns has been set to partly extend out of the screed 25 in the setting of the test patterns.

### Fifth Embodiment

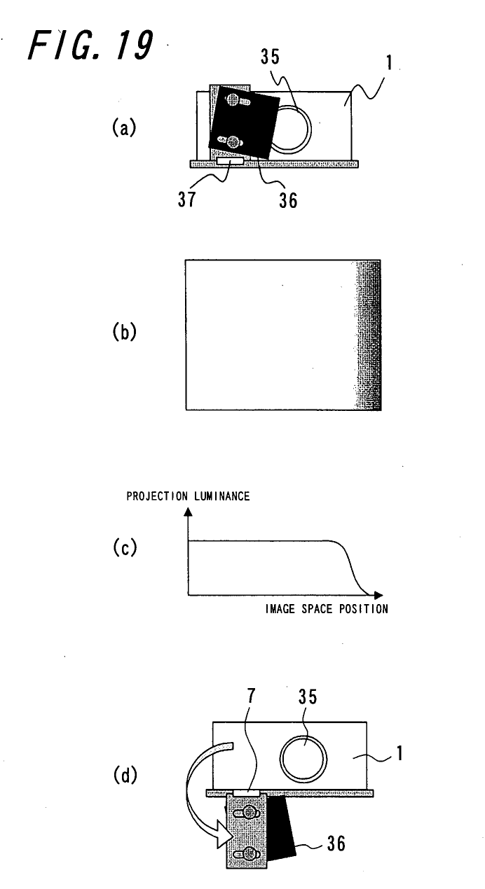

FIGS. 19 to 21 illustrate the configuration of the fifth embodiment according to the invention.

The present embodiment comprises a light shielding plate 36 inserted in front of a projector 1 for shielding part of the light exiting from the lens 35 of the projector 1 as shown in FIG. 19(a), in addition to the configuration of the first embodiment. In this case, however, the term “projector 1” is to be broadly understood as signifying the whole respective projectors such as the projectors 1A, 1B and the like for composing the multi-projection system of the configuration of the first embodiment.

By inserting such a light shielding plate 36, the luminance of the boundaries of the images projected from the respective projectors 1 to the screen 2 can be smoothly lowered as exemplified by the image projected on the screen 2 in FIG. 19(b) and projected luminance of the image space in FIG. 19(c). In this way, unevenness in luminance at the overlapping portions of the images projected by a plurality of projectors can be reduced, thereby enabling improvement in quality of the combined images.

However, when the test pattern images are projected from the respective projectors 1 with the light shielding plate 36 inserted, there may be a possibility that feature points near the boundaries of the images are eclipsed by the light shielding plate, which would make it impossible to perform the capturing and the position detection.

In the present embodiment, therefore, the light shielding plate 36 is made as an opening/closing type using an opening/closing mechanism 37 as shown in FIG. 19(d). When the test pattern images are projected and captured, the light shielding plate 36 is opened, while after the test pattern images have been captured, the light shielding plate 36 is inserted again. In this way, the alignment or positioning of the respective projectors 1 can be effected with high accuracy even at the light shielding portions. Furthermore, after the images have been combined, the elevation in luminance at the overlapping portions of the images can be reduced as described above, thereby enabling the image quality to be improved.

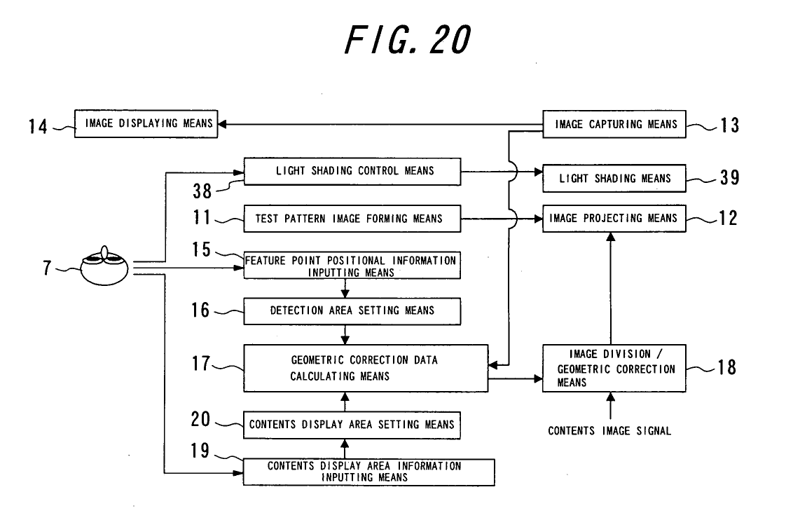

FIG. 20 illustrates the constitution of the geometric correction means according to the present embodiment. In the present embodiment, light shielding control means 38 and light shielding means 39 are provided in addition to the constitution of the geometric correction means (FIG. 3) in the first embodiment. The light shielding means 39 is the light shielding plate 36 of the opening/closing type described above. The light shielding control means 38 outputs control signals to the light shielding means 39 by inputting operation of the operator 7 for opening the light shielding plate 36 when projecting and capturing the test pattern images, while the light shielding control means 38 outputs control signals to the light shielding means 39 for inserting the light shielding plate 36 after the test patterns have been captured. The other components, that is, the test pattern image generating means 11, image projecting means 12, image capturing means 13, image display means 14, feature point position information inputting means 15, detection area setting means 16, geometric correction data calculating means 17, image division/geometric correction means 18, contents display area information inputting means 19, and contents display area setting means 20 are substantially the same as those in the first embodiment described above, so that their explanation is omitted.

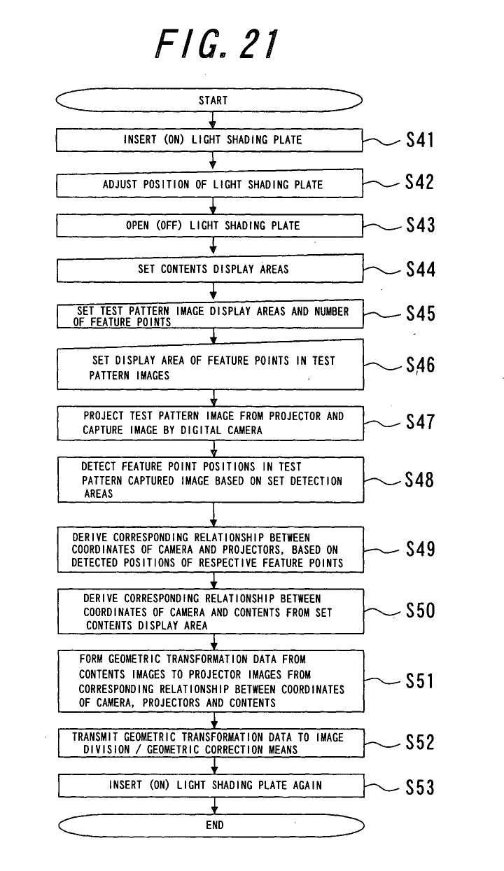

FIG. 21 is a flow chart illustrating the procedure of the processes for the geometric correction method according to the present embodiment. In this case, first of all, the light shielding plate 36 is inserted (step S41), and the position of the light shielding plate 36 is adjusted so that the overlapping portions of the images projected from the projectors become smoothly continuous (step S42). After the adjustment of the positions, the light shielding plate 36 is once opened (step S43).

Thereafter, successive steps from the step S44 for setting the contents display areas to step S52 for transmitting geometric correction data are substantially similar to those from the step S1 to the step S10 in the first embodiment shown in FIG. 5. After the geometric correction data have been transmitted (step S52), the light shielding plate 36 is inserted again as the final step (step S53). In this manner, the alignment or positioning of the respective projectors 1 and the jointing the luminance are all finished. Incidentally, the light shielding plate 36 may be driven automatically or manually in the steps S41, S43, and S53 in FIG. 21.

According to the fifth embodiment described above, even with the case that the light shielding plate 36 is inserted for reducing the unevenness in luminance at the image overlapping portions, the positioning of the plurality of projectors can be performed with high accuracy.

### Sixth Embodiment

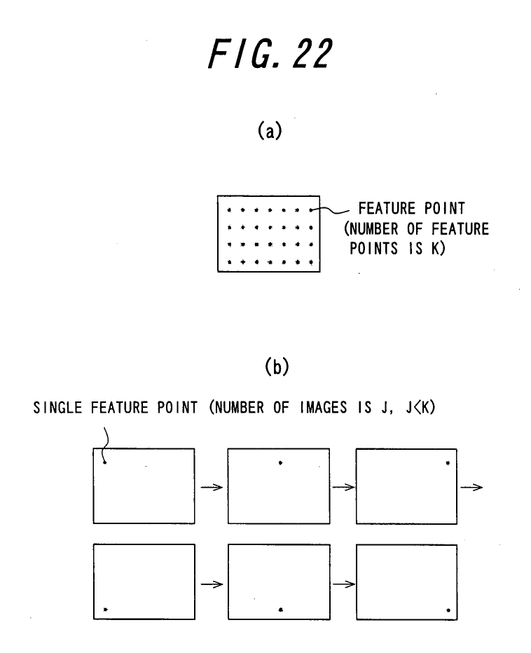

FIGS. 22 to 25 illustrate the configuration of the sixth embodiment according to the invention.

According to the present embodiment, respective capturing operations can be effected by sequentially projecting a plurality of single feature point images displaying only one feature point in the test pattern images as shown in FIG. 22(b) together with test pattern images as shown in FIG. 22(a). In this case, the single feature point images are produced only for some typical feature points in the test pattern images, instead of being produced for all the feature points in the test pattern images. Namely, assuming that the number of the feature points finely arranged in a test pattern image in FIG. 22(a) is K and the number of the single feature point images shown in FIG. 22(b) is J, J is less than K (J<K). In this way, one feature point need only be detected from each of the images captured by projecting a single feature point, so that an automatic detection can be effected without the need for an operator 7 to set the detection areas manually.

After the automatic detection of all the single feature points, linear interpolation or polynomial interpolation is effected to approximately derive the coordinate transformation equations between the projector images and the captured images as in the first embodiment described above. By using the coordinate transformation equations, approximate positions (detection areas) of all the feature points in the test pattern captured images of FIG. 22(a) are automatically set. In this way, the detection areas for the test pattern images composed of fine feature points can be automatically set without need for the operator 7 to manually set the detection areas at all.

Furthermore, although the method for automatically performing the geometric correction by independently capturing the respective feature points is already disclosed in the patent document 2 identified above, this known method is to capture all the feature points in the test pattern images individually, requiring very long capturing time in the case of numerous feature points. In contrast, according to the present embodiment, a two stage system is employed in which only typical feature points are captured individually and the numerous feature points finely arranged are captured altogether at a time as test pattern images separately, so that the capturing time can be extremely shortened in comparison to the above-mentioned known method.

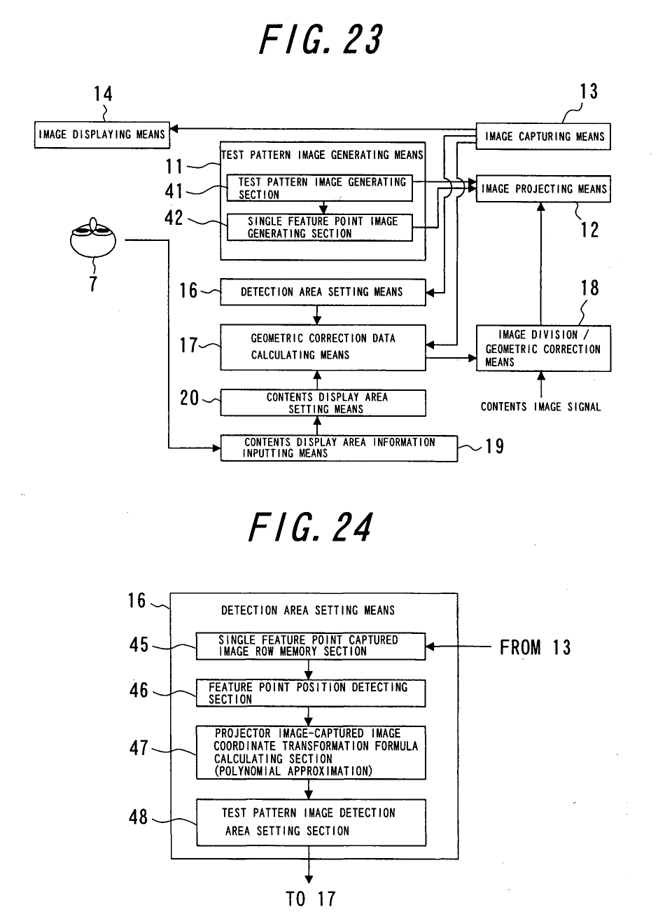

FIG. 23 illustrates the constitution of the geometric correction means according to the present embodiment. The geometric correction means according to the present embodiment mainly differs from those (refer to FIG. 3) of the first embodiment described above in test pattern image generating means 11 and detection area setting means 16.

Namely, the test pattern image generating means 11 comprises a test pattern image generating section 41 for producing the test pattern images as shown in FIG. 22(a) similar to that in the configuration of the first embodiment, and a single feature point image generating section 42 for producing the single feature point images (plural in number) as shown in FIG. 22(b). The test pattern images produced by the test pattern image generating means 11 and the plurality of single feature point images are sequentially input one after another into the image projecting means 12 to be projected onto the screen 2, and the projected images are sequentially captured by the image capturing means 13.

The test pattern captured images captured by the image capturing means 13 are input into the geometric correction data calculating means 17. On the other hand, the respective single feature point captured images captured by the image capturing means 13 are input into the detection area setting means 16. In the present embodiment, moreover, only the screen captured images for use in contents display area setting are input into the image display means 14, and the test pattern captured images and the single feature point images are not input into the image display means 14.

The detection area setting means 16 calculates the approximate positions (detection areas) of the respective feature points in the test pattern captured images by the method described below, based on the respective single feature point captured images input from the image capturing means 13, and outputs the calculated results into the geometric correction data calculating means 17. The other components, that is, geometric correction data calculating means 17, contents display area information inputting means 19, contents display area setting means 20, and image division/geometric correction means 18 are substantially the same as those in the first embodiment so that their explanation is omitted.

The detection area setting means 16 comprises a single feature point captured image row memory section 45, a feature point position detecting section 46, a projector image-captured image coordinate transformation formula calculating section 47, and a test pattern detection area setting section 48 as shown in FIG. 24. The single feature point captured image row memory section 45 stores a plurality of single feature point captured images captured by the image capturing means 13. The feature point position detecting section 46 detects accurate positions of the feature points from the respective single feature point captured images memorized in the single feature point captured image row memory section 45. As the method for detecting positions of the feature points, in this case, one feature point may be detected by setting the detection areas for the overall images in the same manner as described above.

The projector image-captured image coordinate transformation formula calculating section 47 calculates the coordinate transformation formulas between the coordinates of the projector images and the coordinates of the captured images captured by the digital camera 3 as approximate expressions based on the position information of the feature points of the respective single feature point captured images detected by the feature point detecting section 46, and previously given position information of the feature points of the original single feature point images (before being input into the projectors). As the method for calculating the approximate formulas, the formulas may be calculated from the positional relationships between the detected projector images of respective single feature points and the captured images, and the positions of other pixels may be derived by using liner interpolation, polynomial interpolation, and the like.

The test pattern detection area setting section 48 calculates the approximate positions (positions of detection areas) of the respective feature points in the test pattern captured images based on the coordinate transformation formulas between the projector images and captured images calculated in the projector image-captured image coordinate transformation formula calculating section 47 and the previously given position information of feature points in the original test pattern images (before being input into the projectors), and outputs the calculated results into the geometric correction data calculating means 17 in the latter stage.

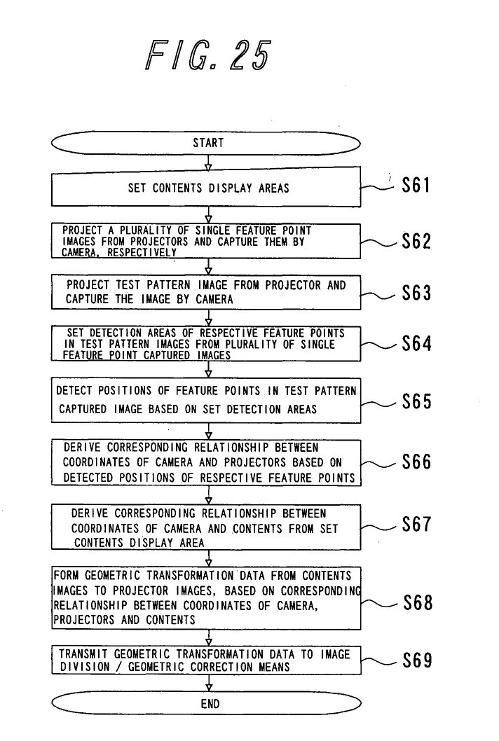

FIG. 25 is a flow chart illustrating the outline of the procedure for the geometric correction method according to the embodiment described above, which comprises steps S61 to S69. The general outline of these steps overlaps with the above explanation, so that their explanation is omitted.

According to the sixth embodiment described above, the detection areas of the test pattern images composed of fine feature points can be automatically set without the need for an operator 7 to set the detection areas at all, thereby enabling geometric correction data to be obtained in a short period of time.

### Seventh Embodiment

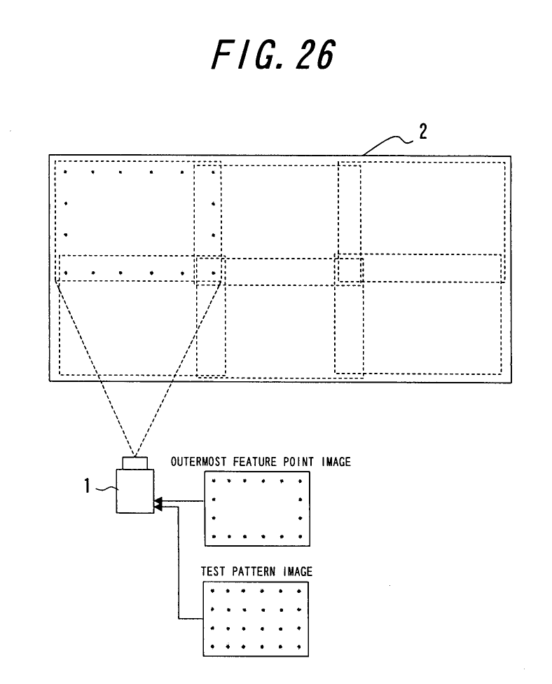

FIG. 26 illustrates the configuration of the seventh embodiment according to the invention.

According to the present embodiment, instead of the single feature point images displayed in addition to the test pattern images in the configuration of the sixth embodiment, one outermost feature point image displayed only by the feature points arranged in the outer peripheries of the test pattern images as shown in FIG. 26 is projected by each of the respective projectors 1 so as to be captured by the image capturing means. The remaining constitution and operations are substantially similar to those in the configuration of the sixth embodiment.

The present embodiment is effectively applicable to the case where the screen 2 is flat instead of being curved, while a plurality of projectors 1 are arranged in alignment with one another side by side (FIG. 26 illustrating only one projector 1) and the projected images are not rotated or reversed. Namely, in such a multi-projection system, the feature points are positioned more or less regularly in arrangement and order, so that the respective feature points can be automatically detected in regular order by projecting only a certain number of points without need to project the feature points one by one as is the case with the configuration of the sixth embodiment.

In this way, when the plurality of projectors 1 are arranged in a simplified manner, by projecting and capturing a plurality of typical points at a time and further capturing fine test pattern images, the detection areas of the test pattern images can be automatically set to realize an accurate geometric correction by only two times of capturing for each of the projectors 1. In the case of providing a light shielding plate at the overlapping portions of the projected images as shown in the configuration of the fifth embodiment, it is possible to separate the capturing for the outermost feature point images which would become dark under the influence of the light shielding plate and the capturing for the inner feature points (feature points of test pattern images) not affected by the light shielding plate. It is thus possible to detect the positions without taking care of the difference in luminance caused by the light shielding plate, and errors in detection can be eliminated even with the light shielding plate inserted.

According to the seventh embodiment described above, when the screen 2 has no considerably curved surface and the plurality of projectors 1 are arranged more or less regularly, even if the light shielding plate is arranged at overlapping portions of projected images, it is possible to carry out favorable alignment or positioning of images with the light shielding plate inserted, without opening and closing it.

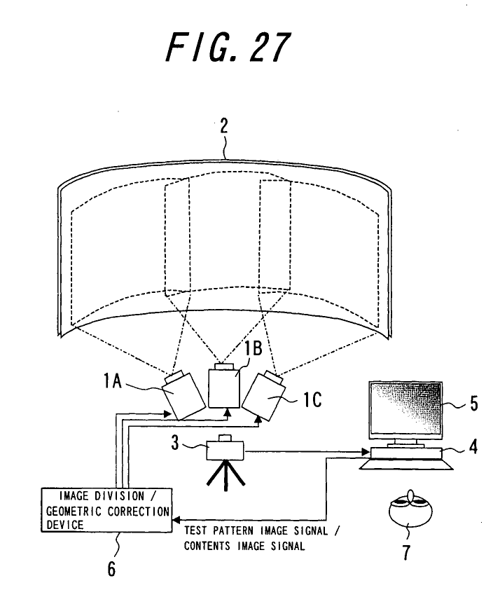

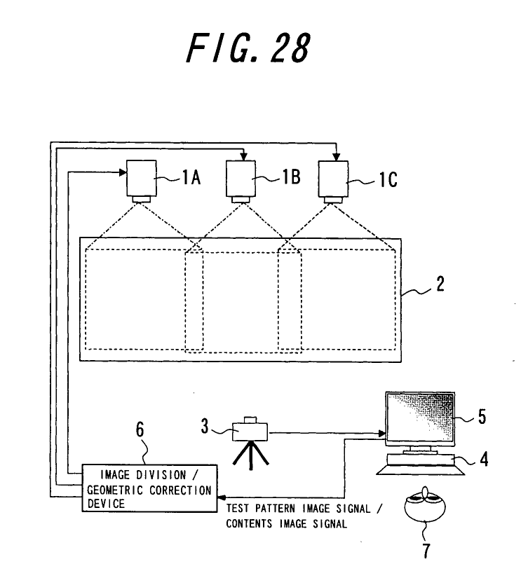

The invention is not to be limited to the configurations of the embodiments described above, and various modifications and variations are possible. For example, the screen 2 is not limited to the dome-shape or flat front projection type; an arch-shaped screen 2 as shown in FIG. 27, or a flat rear projection type screen 2 as shown in FIG. 28 are also applicable to the invention. FIGS. 27 and 28 further illustrate examples using three projectors 1A, 1B and 1C.

1. A geometric correction method in a multi-projection system for displaying a contents image on a screen by combining images projected from a plurality of projectors, including a geometric correction data calculating step for calculating geometric correction data for alignment of the images projected from said projectors, said geometric correction data calculating step comprising:
a projecting step of projecting a test pattern image composed of a plurality of feature points from each of said projectors onto said screen;
a capturing step of capturing the test pattern images projected onto said screen in said projecting step as test pattern captured images obtained by means of capturing means;
a displaying step of displaying on a monitor the test pattern captured images captured in said capturing step;
an inputting step of designating and inputting approximate positions of the feature points in said test pattern captured images, while referring to the test pattern captured images displayed in said displaying step;
a detecting step of detecting accurate positions of the respective feature points in said test pattern images based on the approximate position information input in said inputting step; and
a calculating step of calculating image correction data for the alignment of the images projected by said respective projectors based on the positions of the feature points in said test pattern captured images detected in said detecting step, previously given coordinate information of the feature points in the test pattern images, and separately predetermined coordinate position relationship between the contents images and the test pattern captured images.

2. The geometric correction method in a multi-projection system according to claim 1, wherein:
said inputting step is carried out by designating, as said approximate positions of the feature points in said test patterns captured images, positions of a smaller number of the feature points than the number of the feature points in said test pattern captured images, and inputting the designated positions in a predetermined order previously set; and
said detecting step is carried out by predicting approximate positions of all the feature points in the test pattern images by interpolating operation based on said approximate positions input in said inputting step, and detecting accurate positions of the respective features points in the test pattern images from the predicted approximate positions of the feature points.

3. The geometric correction method in a multi-projection system according to claim 2, wherein said approximate positions of the feature points in said test pattern captured images in said inputting step are positions of a plurality of the feature points positioned in the outermost portions of the test pattern captured images.

4. The geometric correction method in a multi-projection system according to claim 2, wherein said approximate positions of the feature points in said test pattern captured images in said inputting step are positions of four feature points positioned at four outermost corners in the test pattern captured images.

5. The geometric correction method in a multi-projection system according to claim 1, wherein said test pattern images have marks added for identifying the feature points to be designated in said inputting step, beside a plurality of feature points.

6. The geometric correction method in a multi-projection system according to claim 1, wherein said test pattern images have marks added for identifying the order of feature points to be designated in said inputting step, beside a plurality of feature points.

7. The geometric correction method in a multi-projection system according to claim 1, wherein after said capturing step, said geometric correction data calculating step further comprises a light shading step for reducing projection luminance at boundary portions of the images projected by said respective projectors.

8. A geometric correction method in a multi-projection system for displaying a contents image on a screen by combining images projected from a plurality of projectors, including a geometric correction data calculating step for calculating geometric correction data for alignment of the images projected from said projectors, said geometric correction data calculating step comprising:
a projecting step of projecting a test pattern image composed of a plurality of feature points from each of said projectors onto said screen;
a capturing step of capturing the test pattern images projected onto said screen in said projecting step as test pattern captured images obtained by means of capturing means;
a multiple projecting step of sequentially projecting onto said screen a plurality of single feature point images each composed of a different feature point among typical feature points whose number is less than that of the feature points in the test pattern images;
a multiple capturing step of capturing the plurality of single feature point images sequentially projected onto said screen in said multiple projecting step to capture as single feature point captured images;
a preliminary detecting step of detecting accurate positions of the respective feature points from the plurality of single feature point captured images obtained in said multiple capturing step;
a detecting step of detecting accurate positions of the respective feature points in said test pattern captured images based on the positions of the respective feature points in the plurality of single feature point captured images detected in said preliminary detecting step; and
a calculating step of calculating image correction data for alignment of the images projected by said respective projectors based on the positions of the feature points in said test pattern captured images detected in said detecting step, previously given coordinate information of the feature points in the test pattern images, and separately determined coordinate position relationship between contents images and the test pattern captured images.

9. The geometric correction method in a multi-projection system according to claim 8, wherein, in said detecting step, approximate positions of the feature points in said test pattern captured images are predicted by polynomial approximation operation based on the positions of the respective feature points in the plurality of the single feature point captured images detected in said preliminary detecting step to detect accurate positions of the feature points in the test pattern captured images based on the predicted approximate positions.

10. The geometric correction method in a multi-projection system according to claim 8, wherein, after said multiple capturing step and said capturing step, said geometric correction data calculating step further comprises a light shielding step for reducing projection luminance at boundary portions of the images projected by said respective projections.

11. The geometric correction method in a multi-projection system according to claim 8, further comprising:
a screen image capturing step of capturing the entire images on said screen as screen captured images by capturing the entire images on said screen by said capturing means;
a screen image displaying step of displaying the screen captured images obtained in said screen image capturing step onto the monitor;
a contents coordinate inputting step of designating and inputting display area positions of contents images while referring to the screen captured images displayed in said screen image displaying step; and
a calculating step of calculating coordinate position relationship between the contents images and the screen captured images based on the contents display area positions in the screen captured images input in said contents coordinate inputting step;
wherein, in said calculating step, image correction data for the alignment of the images projected by said respective projectors are calculated based on the positions of the feature points in said test pattern captured images detected in said detecting step, previously given coordinate information of the feature points in the test pattern images, separately determined coordinate position relationship between the contents images and the test pattern captured images, and coordinate position relationship between the contents images and the screen captured images calculated in said calculating step.

12. The geometric correction method in a multi-projection system according to claim 11, wherein, in said screen image displaying step, said screen captured images obtained in said screen image capturing step are corrected for distortion depending on lens characteristics of said capturing means to display the corrected images on said monitor.

13. The geometric correction method in a multi-projection system according to claim 1, further comprising:
a screen image capturing step of capturing the entire images on said screen as screen captured images by capturing the entire images on said screen by said capturing means;
a screen image displaying step of displaying the screen captured images obtained in said screen image capturing step onto the monitor;
a contents coordinate inputting step of designating and inputting display area positions of contents images while referring to the screen captured images displayed in said screen image displaying step; and
a calculating step of calculating coordinate position relationship between the contents images and the screen captured images based on the contents display area positions in the screen captured images input in said contents coordinate inputting step;
wherein, in said calculating step, image correction data for the alignment of the images projected by said respective projectors are calculated based on the positions of the feature points in said test pattern captured images detected in said detecting step, previously given coordinate information of the feature points in the test pattern images, separately determined coordinate position relationship between the contents images and the test pattern captured images, and coordinate position relationship between the contents images and the screen captured images calculated in said calculating step.

14. The geometric correction method in a multi-projection system according to claim 13, wherein, in said screen image displaying step, said screen captured images obtained in said screen image capturing step are corrected for distortion depending on lens characteristics of said capturing means to display the corrected images on said monitor.
